(19) United States
(12) Patent Application Publication
(10) Pub. No.: US 2013/0143031 A1
(43) Pub. Date: Jun. 6, 2013

(54) ELECTROLESS NI-COMPOSITE PLATED SUBSTRATE AND METHOD

(71) Applicants: Francesco Sorbo, Massa (IT); Massimo Giannozzi, Florence (IT); Eugenio Giorni, Florence (IT)

(72) Inventors: Francesco Sorbo, Massa (IT); Massimo Giannozzi, Florence (IT); Eugenio Giorni, Florence (IT)

(21) Appl. No.: 13/512,813

(22) PCT Filed: Nov. 24, 2010
(86) PCT No.: PCT/EP2010/068163

§ 371 Date: Jul. 13, 2012

(30) Foreign Application Priority Data
Nov. 30, 2009 (IT) CO2009A000056

(51) Int. Cl. B05D 5/00; B32B 5/16

(52) U.S. Cl. CPC B05D 5/00; B32B 5/16
USPC 428/323; 427/443.1

(57) ABSTRACT

Methods for coating a substrate with wear resistant particles by electroless nickel (Ni) plating. A method includes immersing the substrate in a bath provided in a cell, the bath having a Ni salt; adding cubic Boron Nitride (cBN) particles having a predetermined size to the bath so as to produce a predetermined concentration of cBN; maintaining the substrate in the bath with the cBN particles for a predetermined time; and removing the substrate, wherein the removed substrate has a coating of cBN and Ni in a first range.

### CROSS REFERENCE TO RELATED APPLICATIONS

This is a national stage application under 35 U.S.C. §371(c) of prior-filed, co-pending PCT patent application serial number PCT/EP2010/068163, filed on Nov. 24, 2010, which claims priority to Italian Patent Application Serial No. CO2009A000056, filed on Nov. 30, 2009, the entire contents of which are incorporated herein by reference.

### BACKGROUND OF THE INVENTION

1. Field of the Invention

Embodiments of the subject matter disclosed herein generally relate to methods and systems and, more particularly, to mechanisms and techniques for plating a substrate with a wear resistant coating.

2. Description of the Related Art

Various compressors are used in the petrochemical and oil industry. Many of them are used to pump a process fluid, which may corrode or interact in an undesired way with the material of the compressor. For this reason, various techniques are used for protecting the compressor. One such method is electroless nickel plating (ENP).

ENP produces a nickel phosphorus alloy coating on a substrate. The phosphorus content in electroless nickel coatings can range from 4% to 13%. It is commonly used in engineering coating applications where wear resistance, hardness and abrasion protection are required. Other applications of ENP may include oil field valves, rotors, drive shafts, electrical/mechanical tools, etc.

Due to the high hardness of the coating it can also be used to salvage worn parts. Coatings of 0.001 to 0.004 in. can be applied to the worn components and then the coating may be machined back to final dimensions. Because of its uniform deposition profile, these coatings can be applied to complex components not readily suited to other hard wearing coatings, like chromium based hard wearing coatings.

ENP is an auto-catalytic reaction that does not require an electric current for depositing a coating of nickel on a substrate. This is unlike electroplating, in which it is necessary to pass an electric current through the solution to form a deposit. This plating technique is used to prevent abrasion and wear. ENP techniques can also be used to manufacture composite coatings by suspending powder in a bath in which the substrate is immersed.

ENP has several advantages over electroplating. Free from flux-density and power supply issues, ENP provides an even deposit regardless of workpiece geometry, and, with the proper pre-plate catalyst, can deposit on non-conductive surfaces.

A traditional ENP deposition system is discussed with respect to FIG. 1. The system 10 includes a cell 12 in which a specific bath 14 is provided. The composition of bath 14 varies from application to application and depends on a multitude of factors. A fan 16 may be provided to maintain a homogenous distribution of the contents of the bath 14. A substrate 18, which may be a disc, to be coated is provided on a support 20, which is fully immersed in bath 14. A desired material 22 to be coated on the substrate 18 is added to bath 14 and fan 16 is activated to more uniformly distribute the desired material 22 in the bath and to keep the particles of the material in constant agitation during plating. The desired material 22 may include Ni, P, SiC, BC, and ZrO₂. However, the ENP known compositions have a short life time after being deposited on a compressor sleeve.

Accordingly, it would be desirable to provide systems and methods that avoid the afore-described problems and drawbacks.

### BRIEF SUMMARY OF THE INVENTION

According to an exemplary embodiment, a method for coating a substrate with wear resistant particles by electroless nickel (Ni) plating is provided. The method comprises immersing the substrate in a bath provided in a cell, wherein the bath comprises a Ni salt; adding cubic Boron Nitride (cBN) particles having a predetermined size to the bath so as to produce a predetermined concentration of cBN; maintaining the substrate in the bath with the cBN particles for a predetermined time; and removing the substrate, wherein the removed substrate has a coating of cBN and Ni in a first range.

According to another exemplary embodiment, a method for coating a substrate with wear resistant particles by electroless nickel (Ni) plating is provided. The method comprises immersing the substrate in a bath provided in a cell; adding to the bath cubic Boron Nitride (cBN) particles having a predetermined size and a predetermined concentration and hexagonal BN (hBN) particles having a predetermined size and a predetermined concentration, wherein the bath comprises a Ni salt; maintaining the substrate in the bath with the cBN and hBN particles for a predetermined time; and removing the substrate, wherein the removed substrate has a coating of cBN, hBN, and Ni in a first range.

According to another exemplary embodiment, a substrate is provided. The substrate comprises a coating including wear resistant particles deposited on the substrate by electroless nickel (Ni) plating, wherein the coating comprises cubic Boron Nitride (cBN) particles having a size between about 6 μm and about 20 μm for more than half of the cBN particles.

According to another exemplary embodiment, a substrate is provided. The substrate comprises a coating including wear resistant particles deposited on the substrate by electroless nickel (Ni) plating, wherein the coating comprises hexagonal Boron Nitride (hBN) and cubic Boron Nitride (cBN) particles, the cBN particles having a size between about 6 μm and about 12 μm for more than half of the particles and the hBN particles having a size between about 6 μm and about 10 μm for more than half of the particles.

### BRIEF DESCRIPTION OF THE DRAWINGS

The accompanying drawings, which are incorporated in and constitute a part of the specification, illustrate embodiments of the present invention and, together with the description, explain these embodiments. In the drawings:

FIG. 1 is a schematic diagram of a conventional electroless nickel plating system;

FIG. 2 is a flow chart illustrating chemical reactions involved in the Ni deposit;

FIG. 3 illustrates various composite materials used for coating a substrate according to an exemplary embodiment;

FIG. 4 illustrates a metal loss for the various composite materials of FIG. 3;

FIG. 5 is a graph illustrating average weight loss of the various composite materials of FIG. 3;

FIG. 6 is a graph illustrating average wear rates of the various composite materials of FIG. 3;

FIG. 7 is a table illustrating the numerical values for the weight loss and wear rates of the various composite materials of FIG. 3;

FIG. 8 is a schematic diagram of a system for coating a substrate with one or more of the composite materials of FIG. 3 according to an exemplary embodiment;

FIG. 9 is a schematic diagram of a system for coating a substrate with one or more of the composite materials of FIG. 3 according to another exemplary embodiment;

FIG. 10 is a flow chart illustrating a method for coating a substrate with cBN and Ni particles according to an exemplary embodiment; and

FIG. 11 is a flow chart illustrating a method for coating a substrate with cBN and hBN and Ni particles according to an exemplary embodiment.

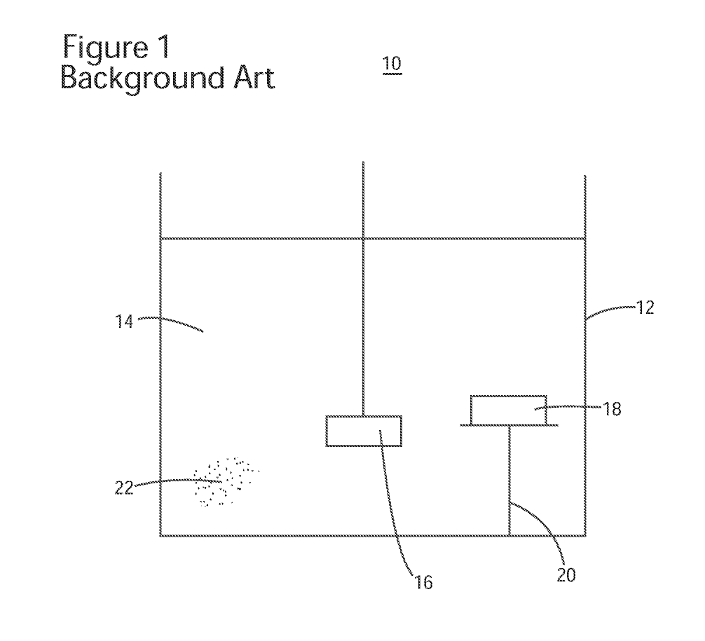

### DETAILED DESCRIPTION OF THE INVENTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a reciprocating compressor. However, the embodiments to be discussed next are not limited to these systems, but may be applied to other substrates that operate in corrosive environments or experience mechanical wear.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

As discussed above, ENP coatings are known in the art. However, the ENP coatings may include ceramic particles (ENP-composite) to enhance the mechanical properties of the substrate on which the coating is applied. Some ENP-composite as ENP-Al₂O₃ and ENP-SiC are also known in the art. However, the known ENP-composites have not produced coatings having the desirable strength and wear resistance.

According to an exemplary embodiment, the following composite materials have been added to the conventional ENP: Silicon Carbide (SiC), Diamond (c-C), cubic Boron Nitride (cBN), as well as self-lubricating particles as hexagonal BN (hBN). Various particle sizes and particle concentrations have been investigated as discussed later. Some of the investigated new compositions show remarkable properties compared to others, thus resulting in coatings that are able to experience mechanical wear and/or corrosive environments. However, it is noted that there is a large number of combinations of Ni and other particles to investigate. Further complications arise due to the large variety of particle sizes and particle concentrations, to name only a few, of the particles to be added to the ENP.

Thus, it is noted that it would not be obvious to one skilled in the art to combine the right size and/or concentration of known particles with the conventional ENP as this art is not predictable and a small change in one of the parameters of the particles may result in large changes in the properties of the coatings as will be discussed later.

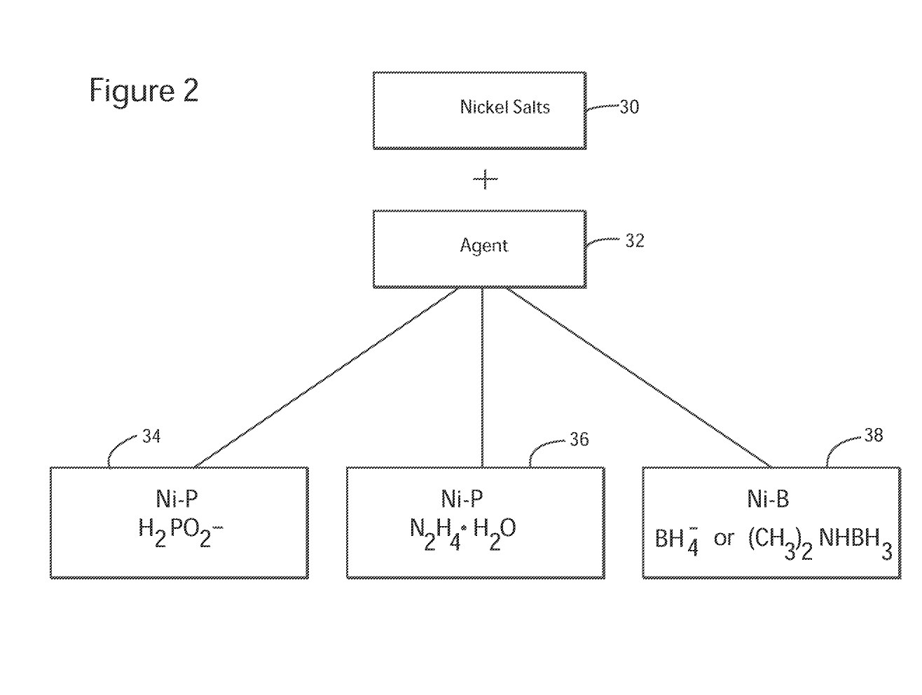

According to an exemplary embodiment, the components of a bath and their effect are discussed with reference to FIG. 2. FIG. 2 shows that two components of the bath 14 are nickel salts 30 and reducing agents 32. The nickel salts 30 provide the material (Ni) for coating deposition and the reducing agents are responsible for the nickel ions reduction. As a consequence of the interaction of the nickel salts 30 with the reducing agents 32 in cell 12, various Ni coatings are obtained. For example, a Ni-P coating 34 or Ni-P coating 36 or Ni-B coating 38 may be obtained depending on the reducing agent used. In one application, only Sodium Hypophosphite is used as the reducing agent. Oxidized elements are produced during the coating process as shown in FIG. 2 in boxes 34, 36, and 38.

Baths may be divided into hypophosphite baths and boron and nitrogen compounds based baths. The hypophosphite bath may produce coatings with phosphorus content ranging from 1% wt. to 15% wt. Phosphorus content is strongly dependent on the bath composition and mainly on the pH value of the bath. The more acidic is the plating solution the higher is the phosphorus concentration in the coating. Temperature also affects the bath behavior and it is preferable to not exceed 90° C. As the composition of the bath is complex, a larger number of them may be used with different results.

Ni-B and Ni-N coatings can be deposited from solutions containing boron and nitrogen based reducing compounds. Such coatings show a good resistance to abrasion and wear, even higher than Ni-P alloys. However, their deposition only occurs from alkaline solutions, e.g., pH between 8 and 14 for Ni-B alloy deposition and between 8 and 10 for Ni-N alloy deposition.

This drawback is relevant because under these conditions a good adhesion on steel substrates cannot be achieved. The reducing compounds employed for the preparation of Ni-B layer are sodium borohydride and dymethylamine borane while the reducing compound for the Ni-N deposition uses hydrazine.

Other additives that may be used are organic ligands, speeding agents, stabilizing agents, pH controllers, and/or wetting agents. The additives are used for improving the stability of the electroless baths and for maintaining a constant deposition speed, e.g., between 10 and 20 μm/h.

To obtain ENP-composite coatings, a suspension of ceramic particles is added to the bath. Some of the suspended particles may adhere to a surface of a growing deposit (coating) to form inclusions that strengthen the coating. Most of the characteristics of the deposition process are independent of the chemical nature of the ceramic materials. This aspect can be understood considering that the interaction of the ceramic particles with the solution and the growing deposit are due to electrostatic and gravitational forces only.

As electrostatic forces depend on the surface charge of the particles and the gravitational forces are proportional to the mass of the particles, there are limits to the size of the particles that can be included in the coating. Solutions of particles with diameters larger than 30 μm are unstable and tend to precipitate if they are vigorously stirred. On the other hand, if the diameters of the particles are small, the electrostatic forces can lead to coagulation. Such phenomenon can produce inhomogenity in the distribution of the particles in the coating. The coagulation can be avoided by the addition of surfactants in the range of concentration of a few ppm.

According to an exemplary embodiment, a bath having the composition and characteristics listed in Table 1 has been provided in cell 12 and the fan 16 was turned on to maintain the agitation of the bath. Ceramic powders having various compositions have been added to this bath as will be discussed later.

TABLE 1

| | | |
|---|---|---|
| NiS04•6 H2O | 50.9 | g/l |
| NaH2P02•H2O | 30 | g/l |
| CH3COONa•3 H2O | 45 | g/l |
| L-Lactic acid 85% | 24 | ml/l |
| Thiourea | 1.5 | mg/l |

| | |
|---|---|
| pH | 4.0 |
| Temperature | 85 to 90° C. |

Experimental discs 18 were placed in the bath 14 so that ENP-composite deposition is achieved on these discs. In one application, a diameter of the disc is 5 cm. Coatings were applied along an external perimeter of the disc, where a load is charged during wearing tests. More specifically about the wearing tests, ENP solutions have been wear tested using a block-on-disc configuration, which uses a plated 42CrMo4 disc (0.50 mm×10 mm). The disc is rotated such that its periphery contacts a block, which produces the wear in the coating of the disc. Sliding velocity and contact load between the block and the disc may be 1.5 m/s and 80 N. Other values may be used. Wear is measured after a distance of 10,000 m is counted, i.e., the disc rotates a number of times equal to 10,000 divided by a perimeter of the disc. Wear is evaluated measuring samples of metal loss every 2500 m. Three samples for each plating solution are tested. Prior to being tested, the coatings may be age-hardened in an air furnace at 400° C. for 4 hours. For example, if a P content is less than 7%, no heat treatment needs to be performed.

A thickness of the disc may be 1 cm, while a thickness of the contact between the block applying the wear and the disc may be about 8 mm. Abrasion is added to the sliding wear test, at the contact between the block and the disc, by the dispersion of 80 g of 120 mesh of corundum in 40 ml of 0.1 μm alumina suspension and 40 ml of distilled water. The block material (for example, 42CrM04 steel) is heat treated, e.g., quenching and tempering. The size of the disc is not believed to be relevant to the capability of applying the coatings and the same coatings may be deposited in larger compressors, for example, having a size in the order of 10 cm to 10 m. The wear tests used in the exemplary embodiments are further discussed later.

The following coatings have been deposited and investigated. Initially, coatings of Ni-P and Ni-P-composite on a 42CrM04 steel substrate have been deposited. The coatings had a thickness of up to 100 p.m. Thinner or thicker coatings may be obtained depending on an amount of time that the substrate is left in the bath. Deposition of ENP-alumina is achieved using concentrations in the solution ranging from 5 g/l to 20 g/l. Volumetric concentrations are obtained using a suspension of 1 μm alpha alumina particles in the coatings and is found to be 15.8, 9.3 and 8.6 Vol % respectively for 20 g/l, 10 g/l and 5 g/l suspensions. The deposited coatings show a homogeneous distribution of the ceramic inclusions. The hardness of the coatings has been found to be about 980 Knoop with 100 g load. Knoop is a unit for a Knoop hardness test for mechanical hardness used particularly for very brittle materials or thin sheets, where only a small indentation may be made for testing purposes. The Knoop test is performed by pressing a pyramidal diamond point into the polished surface of the test material with a known force, for a specified dwell time, and the resulting indentation is measured using a microscope. Deoxidizing of the substrate surface may be performed by dipping the samples (discs) for less than 60 seconds in a solution containing HCl 30% wt.

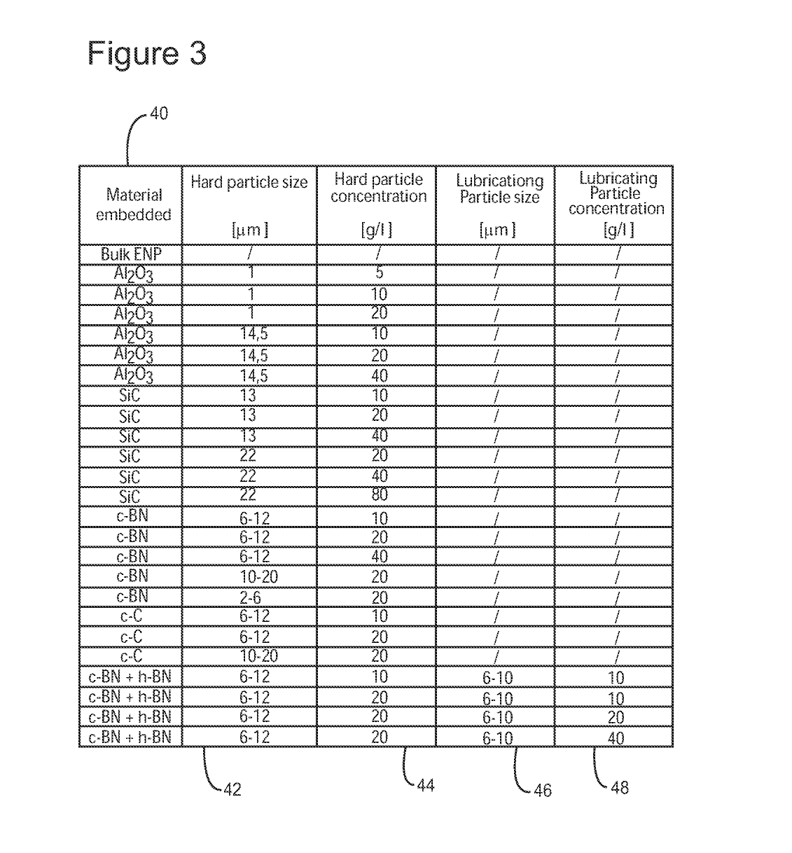

Deposition of ENP Si—C coatings has been performed with particles of different sizes and with different concentrations as shown in FIG. 3. FIG. 3 shows in column 40 the chemical composition of the materials deposited on the substrate. Column 42 indicates a size of the particles being deposited. Column 44 indicates a concentration of the particles deposited. The concentration refers to the concentration of the particles in the bath prior to being deposited on the substrate. Column 46 indicates the size of the lubricating particles and column 48 indicates a concentration of the lubricating particles.

An amount of the embedded SiC particles in the coating has been measured as a function of the SiC particles concentration in the ENP solution. For the examined range of SiC concentrations (e.g., 20, 40 and 80 g/l) and mesh (e.g., 1500, 1000 and 600), where mesh is known in the art to be a number of openings per (linear) inch of a mesh, the embedded ceramic particles are slightly affected by the particle mesh and the content of the ENP bath. An increase of the particles dimensions provides an increase of the embedded particle concentration.

In one exemplary embodiment, all the ENP-SiC coatings have been prepared according to the above noted preparation protocol. The most performing coating (SiC, 600 mesh, 20 g/l) showed a weight loss of 80 mg in the 10,000 m test. The weight loss is the amount of the coating and/or substrate lost due to wear. In terms of thickness, the average loss in the 10,000 m test was found to be in a range between 10 and 15 p.m.

In one exemplary embodiment, the parameter that has been found to have a large effect on the wear resistance of the probe is the particle size of the ceramic. The change of size from mesh 1000 to 600 produces an increase of the wear by a factor of four. On such a basis, a further increase of the particle mesh to 400 have been tried to improve the wear resistance. However, the increase of the particle size increases the weight of the deposited particles, making the deposition of a homogeneous coating a difficult task. Samples deposited under this condition show large differences on the particle distribution along the sample surface.

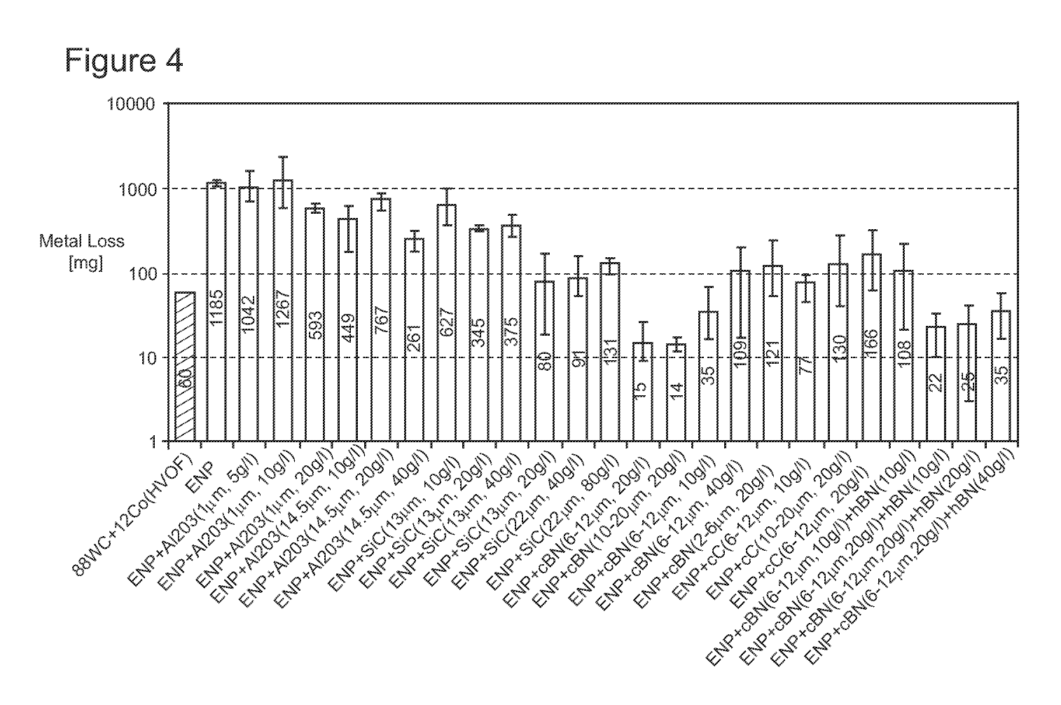

Some parameters of the wear tests performed on the various samples are discussed now. The applied load has been the same for all the investigated samples and was set to 80 N. The sliding speed of the load relative to the sample was 1.5 m/s. Four weight measurements have been performed on each tested sample. The measurement points were: 2500, 5000, 7500 and 10000 m. FIG. 4 lists the various samples studied and their chemical compositions on the X axis and the metal loss due to wear on the Y axis. The samples illustrated in FIG. 4 were age-hardened for about 4 hours at around 400° C.

Each sample used also lists on the X axis the particle size of the ceramic material and the concentration in the bath of the ceramic material. The bars shown in FIG. 4 include a number that is indicative of the metal loss in mg. It is observed that the desired ENP-composite are those having a metal loss of under 60 mg. These composites are ENP+cBN (10-20 μm, 20 g/l); ENP+cBN (6-12 μm, 20 g/l); ENP+cBN (6-12 μm, 20 g/l)+hBN (10 g/l); ENP+cBN (6-12 μm, 20 g/l)+hBN (20 g/l); ENP+cBN (6-12 μm, 20 g/l)+hBN (40 g/l); and ENP+cBN (6-12 μm, 10 g/l). The metal loss for these samples were one fourth of the traditional Tungsten carbide/cobalt (88WC12Co) coating (which is sprayed on a substrate) in terms of weight and about one half in terms of thickness as the WC-Co density is double than that of ENP.

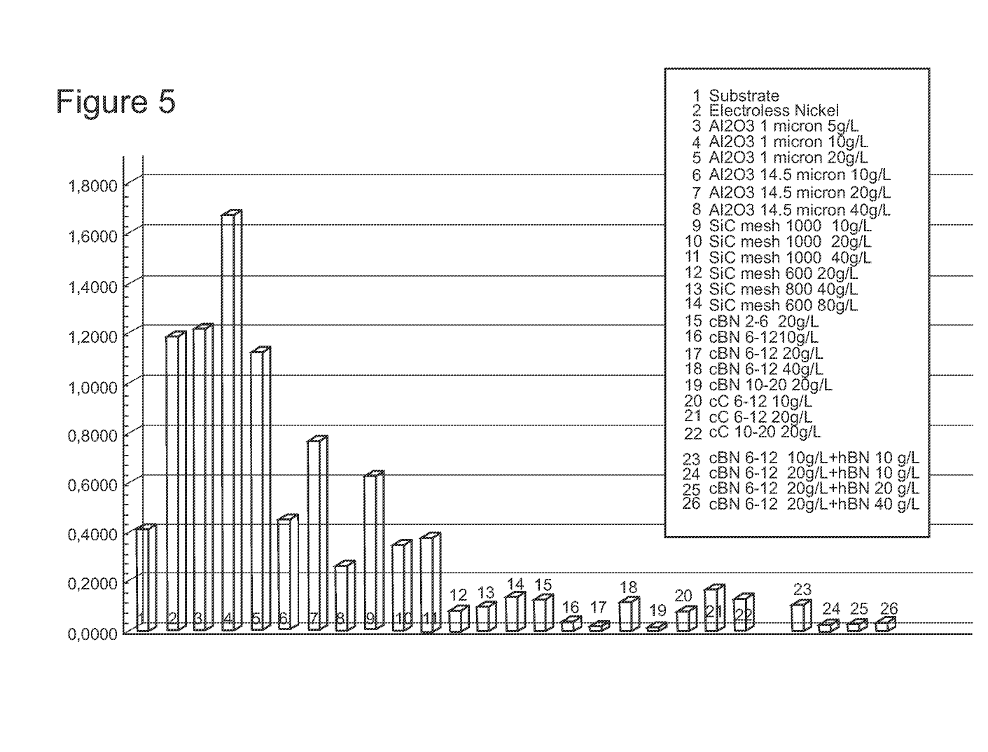

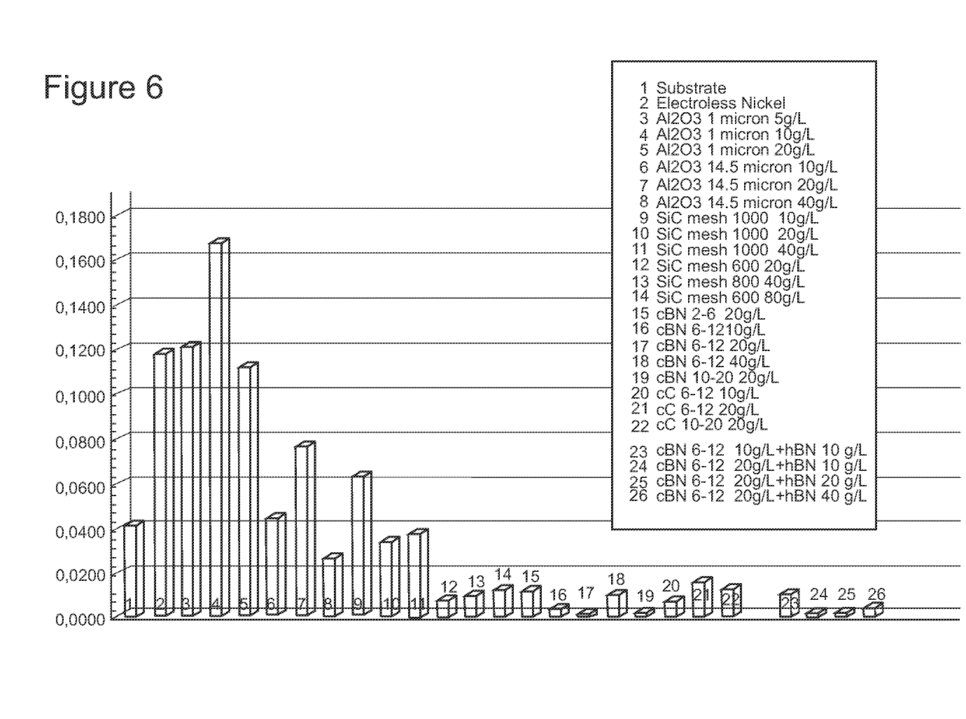

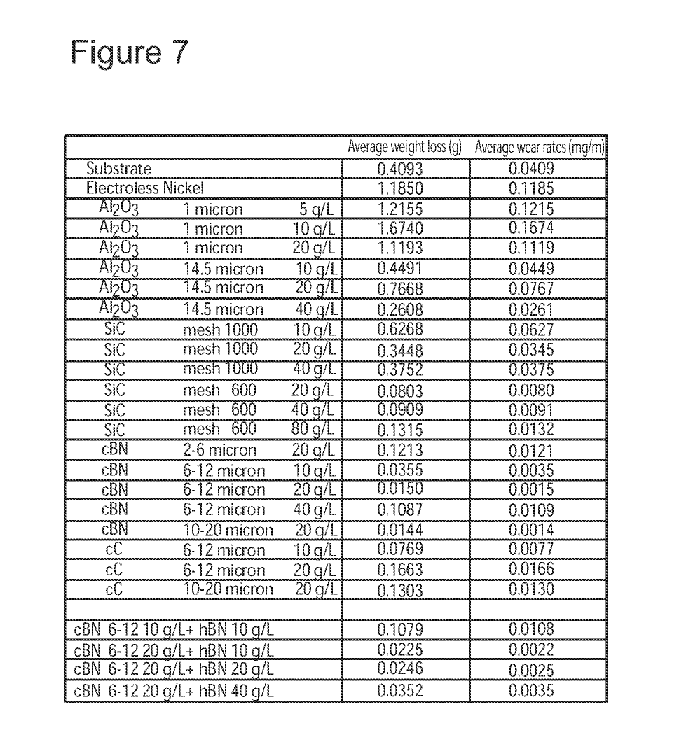

FIGS. 5 and 6 indicate the average weight losses and wear rates for the studied samples. FIG. 7 shows the weight losses and the wear rates for all the studied samples in table format. The most performing coatings are ENP-cBN coatings, with powder mesh 6-12 and 10-20 p.m. The best concentrations of the particles in the solution was 20 g/l (0.0015 mg/m) followed by the 10 g/l (0.0035 mg/m) and the 40 g/l (0.0105 mg/m). An increase of the wear rate with the powder concentration in the deposition suspension has been encountered for all the materials investigated apart from the case of the alumina particles which resulted to be more effective when deposited for 40 g/l solutions. However, the alumina particles appear to not be as effective as silicon carbide, cubic boron nitride and diamond for increasing the wear resistance of the substrate. The best alumina based ENP composite coating provided wear rates which wear ten times and more higher than BN based coatings.

ENP SiC 20 g/l, 600 mesh composite coatings provided intermediate performances showing wear rates of 0.008 mg/m, which are higher than 10 g/l and 20 g/l BN coatings but lower than 40 g/l BN coatings. Diamond composite coatings have also been investigated and showed performances lower than the cBN based coatings.

The addition of the hBN as lubricant has also been considered. Tests have been performed adding the hBN in concentration of 10 and 20 g/l containing 6-12 μm c-BN powders as they have been found to be the most performing coating. However, such an addition did not result in a large enhancement of the wear resistance. Rather wear rates have been found to be slightly higher than the simple EN-cBN coatings (0.0022 mg/m), probably for the consumption of the softer h-BN powder. Further, no enhancement in the resistance of the counter block was found. The best coating in term of wear resistance has been proved to be that obtained from the 20 g/l, 6-12 μm c-BN. It is noted that a coating including particles having a size of 6-12 μm does not imply that each and every particle in that coating has a size in the noted range. According to an exemplary embodiment, more than half of the particles in the coating have a size in the noted range while other particles may have a corresponding size larger or smaller than the noted range. However, according to another exemplary embodiment, it is considered that more than 90% of the particles have their size in the given range.

For the particular field of compressors and associated piping, especially those having complicated geometries, e.g., surfaces that are not easily accessible, the deposition of coatings discussed above have proved to be useful and efficient. Simple ENP coatings are not usually affected by the sample geometry and the coating thickness is homogenous. However, the use of ceramic suspensions is different from simple ENP coatings and requires forced convection of the particles in order to maintain the powder homogeneously suspended.

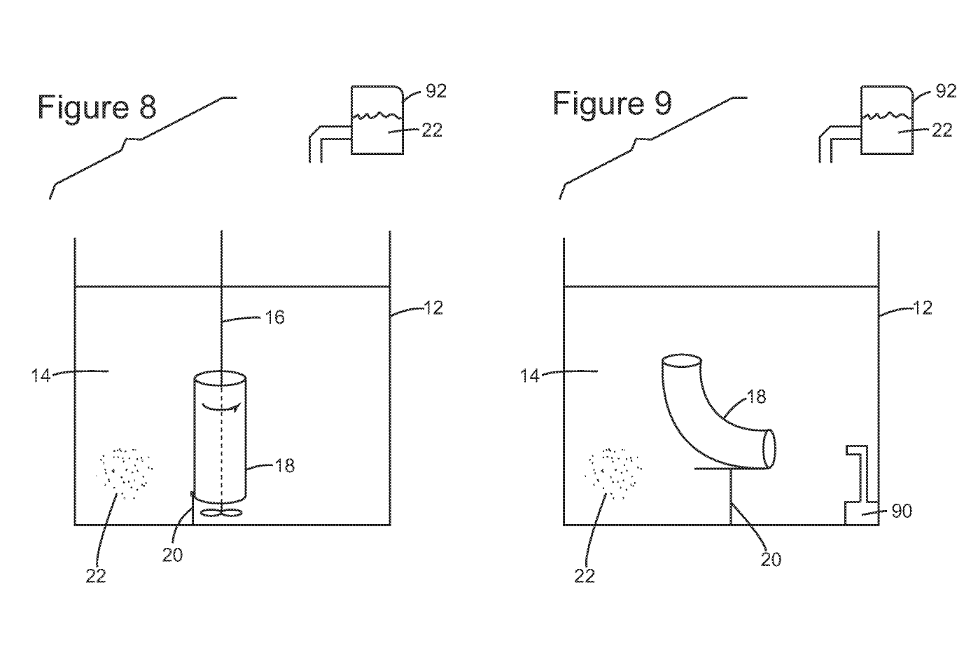

Thus, according to an exemplary embodiment, the fluid flow is maintained either by providing the fan through the substrate 18 to receive the coating as shown in FIG. 8, or by forcing the fluid with a pump 90 to move through inside parts of the substrate 18 as shown in FIG. 9. In one embodiment, a particle source 92 may be provided to supply the particles of desired material 22 as these particles are consumed by the deposition process. The particle source 92 may be configured to continuously and/or constantly provide the desired materials. For the case that more than one type of particles are provided to the bath, more than one particle sources 92 may be used. According to an exemplary embodiment, the substrate 18 is maintained immersed in bath 14 for a predetermined number of hours, which depends on a thickness of the coating desired to be deposited. A thickness of the deposited coating may be between 2 and 500 nm, with a preferred thickness between 50 to 200 nm.

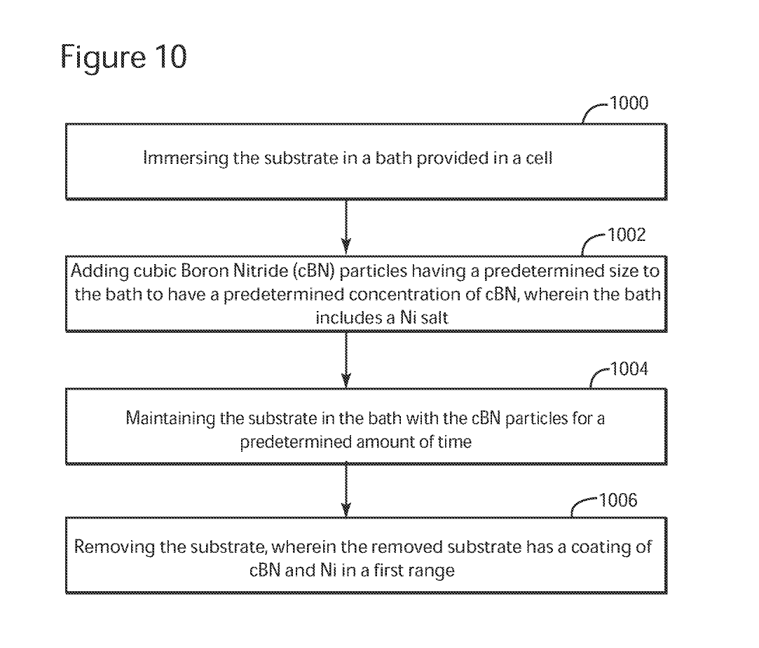

According to an exemplary embodiment, a method for coating a substrate with wear resistant particles by electroless nickel (Ni) plating is discussed with regard to FIG. 10. The method shown in FIG. 10 includes immersing the substrate in a bath provided in a cell 1000, adding cubic Boron Nitride (cBN) particles having a predetermined size to the bath to have a predetermined concentration of cBN 1002, wherein the bath includes a Ni salt; maintaining the substrate in the bath with the cBN particles for a predetermined time 1004, and removing the substrate 1006, wherein the removed substrate has a coating of cBN and Ni in a first range. The first range may be between 50 and 200 nm.

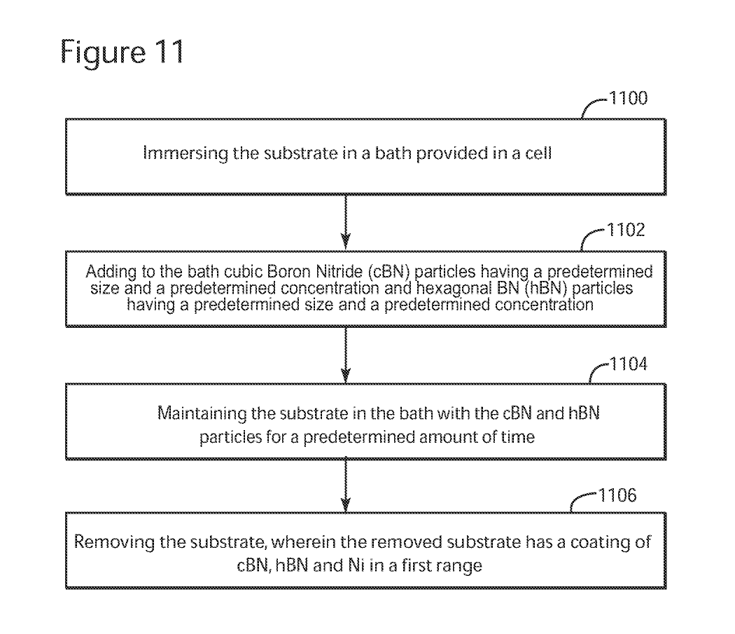

According to another exemplary embodiment, a method for coating a substrate with wear resistant particles by electroless Ni plating is discussed with regard to FIG. 11. The method shown in FIG. 11 includes immersing the substrate in a bath provided in a cell 1100, adding to the bath cubic Boron Nitride (cBN) particles and hexagonal BN (hBN) particles, each having a predetermined size and a predetermined concentration of cBN and hBN 1102, wherein the bath includes a Ni salt, maintaining the substrate in the bath with the cBN and hBN particles for a predetermined time 1104, and removing the substrate 1106, wherein the removed substrate has a coating of cBN, hBN, and Ni in a first range. The first range may be between 50 and 200 nm. In both methods, after the coated substrate is removed from the bath, a heat treatment may be applied, for example, for about 4 hours and at about 400° C. Other values may be used depending on the application and the content of P.

According to another embodiment, the method may further comprise at least one of stirring continuously the bath and cBN particles while the substrate is in the bath, heat treating the coating on the substrate for about 4 hours at a temperature of about 400° C., the substrate being a compressor part, and providing a fan through the compressor part.

The disclosed exemplary embodiments provide a system, substrate and method for coating the substrate with wear resistant particles by an electroless Ni plating. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other example are intended to be within the scope of the claims.

What is claimed is:

1. A method for coating a substrate with wear resistant particles by electroless nickel (Ni) plating, the method comprising:
immersing the substrate in a bath provided in a cell, wherein the bath having comprises a Ni salt;
adding cubic Boron Nitride (cBN) particles having a predetermined size to the bath so as to produce a predetermined concentration of cBN;
maintaining the substrate in the bath with the cBN particles for a predetermined time; and
removing the substrate, wherein the removed substrate has a coating of cBN and Ni in a first range.

2. The method of claim 1, wherein the predetermined size is between about 6 μm and about 20 μm for more than half of the cBN particles, the predetermined concentration is between about 18 g/l and about 25 g/l, and the first range is between about 50 μm and about 200 μm.

3. The method of claim 1, wherein the predetermined size is between about 6 μm and about 20 μm for more than half of the cBN particles, the predetermined concentration is between about 8 g/l and about 15 g/l, and the first range is between about 50 μm and about 200 μm.

4. The method of claim 1, further comprising:
supplying additional cBN particles to the bath while coating the substrate to compensate for those cBN particles that deposit on the substrate.

5. A method for coating a substrate with wear resistant particles by electroless nickel (Ni) plating, the method comprising:
immersing the substrate in a bath provided in a cell, wherein the bath includes comprises a Ni salt;
adding to the bath cubic Boron Nitride (cBN) particles having a predetermined size and a predetermined concentration and hexagonal BN (hBN) particles having a predetermined size and a predetermined concentration;
maintaining the substrate in the bath with the cBN and hBN particles for a predetermined amount of time; and
removing the substrate, wherein the removed substrate has a coating of cBN, hBN, and Ni in a first range.

6. The method of claim 5, wherein the predetermined size of the cBN particles is between about 6 μm and about 12 μm for more than half of the cBN particles and the predetermined concentration of the cBN particles in the bath is between about 18 g/l and about 25 g/l, the predetermined size of the hBN particles is between about 6 μm and about 10 μm for more than half of the hBN particles and the predetermined concentration of the hBN particles in the bath is between about 8 g/l and about 45 g/l, and the first range is between about 50 μm and about 200 μm.

7. The method of claim 5, wherein the predetermined size of the cBN particles is between about 6 μm and about 12 μm for more than half of the cBN particles and the predetermined concentration of the cBN particles in the bath is between about 8 g/l and about 15 g/l, the predetermined size of the hBN particles is between about 6 μm and about 10 μm for more than half of the hBN particles and the predetermined concentration of the hBN particles in the bath is between about 8 g/l and about 15 g/l, and the first range is between about 50 μm and about 200 μm.

8. The method of claim 7, further comprising:
supplying additional cBN and hBN particles while coating the substrate to the bath to compensate for those particles that deposit on the substrate.

9. A substrate, comprising:
a coating including wear resistant particles deposited on the substrate by electroless nickel (Ni) plating, wherein the coating comprises cubic Boron Nitride (cBN) particles having a size between about 6 μm and about 20 μm for more than half of the cBN particles.

10. A substrate, comprising:
a coating including wear resistant particles deposited on the substrate by electroless nickel (Ni) plating, wherein the coating includes comprises hexagonal Boron Nitride (hBN) and cubic Boron Nitride (cBN) particles, the cBN particles having a size between about 6 μm and about 12 μm for more than half of the particles and the hBN particles having a size between about 6 μm and about 10 μm for more than half of the particles.
